(19) United States
(12) Patent Application Publication
(10) Pub. No.: US 2007/0039633 A1
(43) Pub. Date: Feb. 22, 2007

(54) Polymer removing apparatus and method for cleaning inside thereof

(76) Inventor: Sadaharu Tamaki, Miyagi (JP)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/499,781

(22) Filed: Aug. 7, 2006

(30) Foreign Application Priority Data
Aug. 19, 2005 (JP) 2005-238514

(51) Int. Cl. B08B 9/093; B08B 3/00

(52) U.S. Cl. 134/22.18; 134/23; 134/148; 134/153; 134/902

(57) ABSTRACT

A rotating-shaft seal section protective plate including a cylindrical section that covers the periphery of part of a rotating shaft, a small-diameter flange-shaped section formed at an end on the rotor side, of the cylindrical section, and a large-diameter flange-shaped section formed at an end on the rotating-shaft seal section side, of the cylindrical section, is disposed between the rotor and the rotating-shaft seal section. The rotating-shaft seal section protective plate divides the interior of a chamber into a portion on the rotor side and a portion on the rotating-shaft seal section side by means of the large-diameter flange-shaped section and leads a liquid injection medium (corresponding to each of a peeling liquid and a cleaning liquid) to the discharge port by means of the small-diameter flange-shaped portion.

### BACKGROUND OF THE INVENTION

The present invention relates to a polymer removing apparatus which reduces the amount of particles generated inside the apparatus, and to a method of cleaning the inside of the polymer removing apparatus.

<Structure of Polymer Removing Apparatus>

As a type of semiconductor manufacturing equipment, there is known a polymer removing apparatus which removes polymer adhered to wafers from the wafers (refer to, for example, a patent document 1 (Japanese Unexamined Patent Publication No. Hei 6(1994)-260473 (paragraphs 18 to 98 and FIGS. 2 through 42).

A configuration of a polymer removing apparatus will be explained below referring to FIGS. 7(A) and 7(B). Incidentally, FIG. 7(A) is a diagram showing the outward appearance of the polymer removing apparatus. FIG. 7(B) is a diagram showing the configuration of the polymer removing apparatus in which a chamber shown in FIG. 7(A) is partly cut away.

The polymer removing apparatus 10 has a chamber 102, a rotor 104, a rotating shaft 106 and a drive unit 108.

The chamber 102 is a barrel or container whose inside is hollow, which accommodates the rotor 104 and the rotating shaft 106 and the like therein.

The chamber 102 includes a plurality of nozzles provided on its inner wall, which inject liquid or gaseous injection mediums to wafers 500. Here, the number of nozzles is set to three, which are respectively called first nozzles 112, second nozzles 114 and third nozzles 116. These nozzles are provided on the inner wall of the chamber 102 in such a manner that their injection holes are directed to the rotating shaft 106. Further, the chamber 102 is provided thereinside with an exhaust or discharge port 118 which discharges injection mediums (mainly a peeling liquid 600 and a cleaning liquid 700) to the outside. Incidentally, the liquid injection mediums are assumed to be the peeling liquid 600 and the cleaning liquid 700, and the gaseous injection medium is assumed to be drying nitrogen 800 (refer to FIGS. 8-1 through 8-3). The first nozzles 112 and the second nozzles 114 inject the peeling liquid 600 and the cleaning liquid 700 by switching. On the other hand, the third nozzles 116 inject the drying nitrogen 800.

The rotor 104 is a rotor disposed inside the chamber 102 and rotated about the rotating shaft 106. The rotor 104 accommodates therein a wafer carrier 120 which bears the wafers 500 and holds the wafers 500 fixed to the wafer carrier 120 by a wafer stopper 122. Further, the rotor 104 is rotated in its state in response to a turning force or torque from the drive unit 108 via the rotating shaft 106.

The rotating shaft 106 is a drive transfer mechanism which connects the rotor 104 and the drive unit 108 and transfers the turning force from the drive unit 108 to the rotor 104. Incidentally, the rotating shaft 106 is used to seal between the rotating shaft 106 and the chamber 102 by means of a rotating-shaft seal section 124.

The drive unit 108 is a drive source such as a motor or the like, which generates a turning force. The drive unit 108 is disposed outside the chamber 102 and connected to the rotor 104 disposed inside the chamber 102 through the rotating shaft 106. The drive unit 108 rotates and drives the rotor 104 by applying the turning force or torque to the rotating shaft 106. Thus, the wafer carrier 120 held inside the rotor 104 is rotated, so that the wafers 500 borne by the wafer carrier 120 are rotated.

The polymer removing apparatus 10 injects the peeling liquid 600 and the cleaning liquid 700 to the wafers 500 through the first nozzles 112 and the second nozzles 114 provided around the rotor 104 while rotatably driving the rotor 104 by means of the drive unit 108 in a state in which the wafer carrier 120 bearing the wafers 500 is being accommodated in the rotor 104. Thus, the polymer removing apparatus 10 removes polymers adhered to the wafers 500 from the wafers 500 by these peeling and cleaning liquids 600 and 700.

<Operation of Polymer Removing Apparatus>

Cleaning operations of the polymer removing apparatus 10 will be described below referring to FIGS. 8-1 through 8-3. Incidentally, here, the cleaning operations means both the operation of removing polymer from the wafers 500 and the operation of washing out the peeling liquid 600 from the inner wall of the chamber 102 with the cleaning liquid.

FIG. 8-1 is a diagram for describing a state in which the polymer removing apparatus 10 injects the peeling liquid 600. FIG. 8-2 is a diagram for describing a state in which the polymer removing apparatus 10 injects the cleaning liquid 700. FIG. 8-3 is a diagram for describing a state in which the polymer removing apparatus 10 injects the drying nitrogen 800. Incidentally, FIG. 8-1(A) through 8-3(A) in FIGS. 8-1 through 8-3 are respectively diagrams showing internal configurations of the polymer removing apparatus 10 as viewed from above. FIGS. 8-1(B) through 8-3(B) to FIGS. 8-1(D) through 8-3(D) in FIGS. 8-1 through 8-3 are respectively diagrams showing internal configurations of the polymer removing apparatus 10 as viewed from the side. Incidentally, each of FIGS. 8-1(B) through 8-3(B) is a diagram showing an internal state of the polymer removing apparatus 10 in which the chamber 102 is cut along line b-b in each of FIGS. 8-1(A) through 8-3(A). Each of FIGS. 8-1(C) through 8-3(C) is a diagram showing an internal state of the polymer removing apparatus 10 in which the chamber 102 is cut along line c-c in each of FIGS. 8-1(A) through 8-3(A). Each of FIGS. 8-1(D) through 8-3(D) is a diagram showing an internal state of the polymer removing apparatus 10 in which the chamber 102 is cut along line d-d in each of FIGS. 8-1(A) through 8-3(A).

Incidentally, in FIGS. 8-1(A) through 8-3(A) in FIGS. 8-1 through 8-3, the positions of the first nozzles 112 and the second nozzles 114 are shown with being shifted to indicate that the first nozzles 112 and the second nozzles 114 inject the injection mediums. That is, the first nozzles 112 and the second nozzles 114 are shown so as to be located just beside the rotor 104 in FIGS. 8-1(A) through 8-3(A). However, as shown in FIGS. 8-1(C) through 8-3(C) in practice, the first nozzles 112 and the second nozzles 114 are disposed obliquely upward on the rotor 104 without being positioned just beside the rotor 104.

In the polymer removing apparatus 10 as shown in FIGS. 8-1(A) through 8-1(D), the wafer carrier 120 which bears plural wafers 500 more than one, is accommodated in the rotor 104, and the drive unit 108 rotatably drives the rotor 104 about the rotating shaft 106. Incidentally, at this time, the wafers 500 are fixed to the wafer carrier 120 by the wafer stopper 122. Thus, the wafers 500 are prevented from being displaced in position upon their rotation.

In addition, the polymer removing apparatus 10 injects the peeling liquid 600 to the wafers 500 lying inside the rotor 104 through the first nozzles 112 disposed obliquely upward on the rotor 104, while the rotor 104 is being rotatably driven. Then, the polymer removing apparatus 10 discharges the injected peeling liquid 600 from the discharge port 118 to the outside of the chamber 102. The injected peeling liquid 600 separates or peels off polymer from the wafers 500.

At this time, however, the peeling liquid 600 collides with the rotated rotor 104 and rebounds therefrom. Therefore, the peeling liquid 600 adheres to the inner wall of the chamber 102 and the periphery of the rotating-shaft seal section 124.

Next, as shown in FIGS. 8-2(A) through 8-2(D), the polymer removing apparatus 10 injects the cleaning liquid 700 to the wafers 500 lying inside the rotor 104 through the first nozzles 112 and second nozzles 114 disposed obliquely upward on the rotor 104 while the rotor 104 is being rotatably driven. Then, the polymer removing apparatus 10 discharges the injected cleaning liquid 700 from the discharge port 118 to the outside of the chamber 102. The injected cleaning liquid 700 washes out the peeling liquid 600 adhered to the wafers 500 and the inner wall of the chamber 102.

At this time, however, spots to which the cleaning liquid 700 is not applied sufficiently occur inside the chamber 102. Therefore, the peeling liquid 600 (hereinafter called remaining or residual peeling liquid 602) remains inside the chamber 102. Incidentally, as such spots may be mentioned, particularly, the inner wall of the chamber 102 in the vicinity of its ceiling, the inner wall of the chamber 102 in the vicinity of the first nozzles 112, the inner wall of the chamber 102 in the vicinity of the second nozzles 114, the inner wall of the chamber 102 in the vicinity of its corner (i.e., its inner portion at the corner), and the periphery of the rotating-shaft seal section 124.

Next, as shown in FIGS. 8-3(A) through 8-3(D), the polymer removing apparatus 10 injects the drying nitrogen 800 from the third nozzles 116 to dry the wafers 500 and the inner wall of the chamber 102, and the like. At this time, the residual peeling liquid 602 is transformed into a crystalline body (called crystallized peeling liquid 604). When the polymer removing apparatus 10 is operated, the crystallized peeling liquid 604 is split into fine particles by vibrations generated thereby and flows into the chamber 102. When the particles fall on the wafers 500 at this time, the wafers 500 are contaminated so that the yields of wiring for the wafers 500 are degraded.

In the conventional polymer removing apparatus, the amount of the particles developed inside the apparatus increases because the amount of the residual peeling liquid inside the apparatus is large. Therefore, the conventional polymer removing apparatus is accompanied by a problem that the contamination of each wafer by the particles occurs at a high-frequent rate and the yields of wiring for the wafers are degraded.

Thus, the conventional polymer removing apparatus has the need for discarding a large number of contaminated wafers.

In the conventional polymer removing apparatus, the rotating-shaft seal section is eroded by the peeling liquid adhered to the rotating-shaft seal section. Therefore, the conventional polymer removing apparatus is accompanied by a problem that the lifetime of the rotating-shaft seal section is short.

Accordingly, there is a need to replace the rotating-shaft seal section with another at an early stage in the conventional polymer removing apparatus.

### SUMMARY OF THE INVENTION

The present invention aims to provide a polymer removing apparatus capable of applying a vigorous or powerful cleaning liquid to spots (specifically such as the inner wall of a chamber in the vicinity of its ceiling, the inner wall of the chamber in the vicinity of each nozzle, the inner wall of the chamber in the vicinity of its corner, the periphery of a rotating-shaft seal section, etc.) to which the cleaning liquid has heretofore been unapplied sufficiently, and a method of cleaning the inside of the polymer removing apparatus.

In order to attain the above object, there is provided a polymer removing apparatus according to a first invention, which includes a chamber whose inside is hollow. A plurality of nozzles which inject liquid or gaseous injection mediums to wafers lying in the chamber, are disposed on an inner wall of the chamber. Incidentally, the liquid injection mediums are a peeling liquid and a cleaning liquid, for example, and the gaseous injection medium is drying nitrogen, for example. An exhaust or discharge port which discharges the injection mediums injected through the nozzles to the outside of the chamber, is disposed inside the chamber. Further, a rotor with a wafer carrier held therein is disposed inside the chamber, and a drive unit for rotating the rotor is disposed outside the chamber. And the rotor and the drive unit are connected to each other by a rotating shaft. Incidentally, a rotating-shaft seal section seals between the rotating shaft and the chamber. A rotating-shaft seal section protective plate for protecting the rotating-shaft seal section from the injection mediums injected through the nozzles is disposed between the rotor and the rotating-shaft seal section. The rotating-shaft seal section protective plate includes a cylindrical section which covers the periphery of part of the rotating shaft over its full circumstance, a large-diameter flange-shaped section formed at an end on the rotating-shaft seal section side, of the cylindrical section, and a small-diameter flange-shaped section formed at an end on the rotor side, of the cylindrical section.

The large-diameter flange-shaped section divides the interior of the chamber into a portion on the rotor side and a portion on the rotating-shaft seal section side.

Thus, the peeling liquid does not enter the portion on the rotating-shaft seal section side lying inside the chamber. Therefore, the polymer removing apparatus according to the first invention is capable of preventing the peeling liquid from being adhered to the rotating-shaft seal section.

The farthest position (hereinafter called “peeling-liquid attainable position”) on the rotating-shaft seal section side where the peeling liquid reaches, is shifted from the cornered position of the inner wall of the chamber to a position where the inner wall of the chamber and the large-diameter flange-shaped section of the rotating-shaft seal section protective plate intersect. Thus, the polymer removing apparatus according to the first invention makes shorter the distance between each of the nozzles and the peeling-liquid attainable position than conventional. This makes the impetus of the cleaning liquid in the vicinity of the peeling-liquid attainable position stronger than conventional. Therefore, the polymer removing apparatus according to the first invention is capable of efficiently washing out the peeling liquid in the vicinity of the peeling-liquid attainable position with the cleaning liquid.

Incidentally, the small-diameter flange-shaped section leads the liquid injection mediums (peeling liquid and cleaning liquid here) to the discharge port with efficiency. Therefore, the polymer removing apparatus according to the first invention is capable of discharging the peeling liquid to the outside of the apparatus with efficiency.

In order to attain the above object, there is provided a polymer removing apparatus according to a second invention, comprising a chamber whose inside is hollow, a plurality of nozzles which are disposed over an inner wall of the chamber and inject a liquid or gaseous injection medium to wafers lying in the chamber, a discharge port which is disposed inside the chamber and discharges the injection medium to the outside of the chamber, a rotor which is disposed inside the chamber and accommodates a wafer carrier bearing the wafers therein, a drive unit which is disposed outside the chamber and rotates the rotor, a rotating shaft which connects the rotor and the drive unit, and a rotating-shaft seal section which seals between the rotating shaft and the chamber.

At least one of the plural nozzles includes a variable mechanism which changes the direction of injection of the injection medium. Incidentally, the nozzle variable mechanism is realized by, for example, a first cylinder provided with plural injections holes at its periphery, and a second cylinder which slides on the interior of the first cylinder and suitably opens and closes some of the plural injection holes of the first cylinder by sliding on the inside of the first cylinder.

The nozzle variable mechanism is capable of injecting the injection medium (cleaning liquid in particular) by changing its injection direction. Thus, the polymer removing apparatus according to the second invention can apply the vigorous cleaning liquid even to spots to which the cleaning liquid has heretofore been unapplied sufficiently. Therefore, the polymer removing apparatus according to the second invention can wash out the peeling liquid with the cleaning liquid with efficiency.

There is further provided a method of cleaning the inside of a polymer removing apparatus, according to a third invention (hereinafter called simply cleaning method according to the third invention). The cleaning method includes the steps of injecting a cleaning liquid to wafers from the periphery of a rotor while rotatably driving the rotor in a state in which a wafer carrier bearing the wafers is being held in the rotor lying inside a chamber, thereby to clean the wafers, replacing the wafer carrier with a cleaning jig having side faces each shaped in a plane fashion, and injecting the cleaning liquid to the side faces of the cleaning jig from the periphery of the rotor while rotatably driving the rotor in a state in which the cleaning jig is being accommodated in the rotor lying inside the chamber, thereby to clean the inside of the chamber. Incidentally, the chamber interior cleaned in the chamber inside cleaning step may include, specifically, the inner wall of the chamber in the vicinity of its ceiling, the inner wall of the chamber in the vicinity of each nozzle, the inner wall of the chamber in the vicinity of its corner, the periphery of the rotating-shaft seal section, etc.

The cleaning jig can splash the cleaning liquid injected through the nozzles toward the inner wall of the chamber with vigorous impetus through the side faces. Accordingly, the cleaning method according to the third invention is capable of applying the powerful or vigorous cleaning liquid even to spots to which the cleaning liquid has heretofore been unapplied sufficiently. Therefore, the present cleaning method can wash out the peeling liquid with the cleaning liquid with efficiency.

In the polymer removing apparatus according to the first invention, the large-diameter flange-shaped section of the rotating-shaft seal section protective plate can prevent the peeling liquid from being adhered to the rotating-shaft seal section.

As a result, the polymer removing apparatus according to the first invention can prevent the rotating-shaft seal section from being eroded by the peeling liquid and make the lifetime of the rotating-shaft seal section longer than conventional. Thus, the polymer removing apparatus according to the first invention needs not to replace the rotating-shaft seal section with another at an early stage.

The polymer removing apparatus according to the first invention makes the distance from each of the nozzles to the peeling liquid attainable position shorter than conventional by means of the large-diameter flange-shaped section of the rotating-shaft seal section protective plate. Thus, the impetus of the cleaning liquid in the vicinity of the peeling liquid attainable position is made stronger than conventional. Therefore, the polymer removing apparatus according to the first invention can wash out the peeling liquid in the vicinity of the peeling liquid attainable position with the cleaning liquid efficiently.

The polymer removing apparatus according to the first invention efficiently leads the liquid injection mediums (peeling liquid and cleaning liquid here) to the corresponding discharge port by means of the small-diameter flange-shaped section of the rotating-shaft seal section protective plate. Therefore, the polymer removing apparatus according to the first invention can further discharge the peeling liquid to the outside of the apparatus with efficiency.

As a result, the polymer removing apparatus according to the first invention can make the amount (i.e., the amount of particles generated inside the apparatus) of the residual peeling liquid lying inside the apparatus less than conventional. Therefore, the polymer removing apparatus according to the first invention can reduce the frequency of occurrence of contamination of the wafers by the particles than conventional and enhance the yields of wiring for the wafers than conventional. Thus, the polymer removing apparatus according to the first invention needs not to discard a large number of wafers.

The polymer removing apparatus according to the second invention can change the injection direction of the injection medium (cleaning liquid in particular) by means of the nozzle variable mechanism. Thus, the polymer removing apparatus according to the second invention is capable of applying the vigorous cleaning liquid even to the spots to which the cleaning liquid has heretofore been unapplied sufficiently. Therefore, the polymer removing apparatus according to the second invention can wash out the peeling liquid with the cleaning liquid with efficiency.

As a result, the polymer removing apparatus according to the second invention can make the amount (i.e., the amount of particles generated inside the apparatus) of the residual peeling liquid lying inside the apparatus less than conventional. Therefore, the polymer removing apparatus according to the second invention can reduce the frequency of occurrence of contamination of the wafers by the particles than conventional and enhance the yields of wiring for the wafers than conventional. Thus, the polymer removing apparatus according to the second invention needs not to discard a large number of wafers.

The method of cleaning the inside of the polymer removing apparatus, according to the third invention (hereinafter called simply cleaning method according to the third invention) is capable of splashing the cleaning liquid toward the inner wall of the chamber with vigorous impetus by means of the side faces of the cleaning jig, each shaped in plane form. Accordingly, the cleaning method according to the third invention can apply the vigorous cleaning liquid even to the spots to which the cleaning liquid has heretofore been unapplied sufficiently. Therefore, the cleaning method according to the third invention can efficiently wash out the peeling liquid with the cleaning liquid.

As a result, the cleaning method according to the third invention can make the amount (i.e., the amount of particles generated inside the apparatus) of the residual peeling liquid lying inside the apparatus less than conventional. Therefore, the cleaning method according to the third invention can reduce the frequency of occurrence of contamination of the wafers by the particles than conventional and enhance the yields of wiring for the wafers than conventional. Thus, the cleaning method according to the third invention needs not to discard a large number of wafers.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a configuration diagram showing a polymer removing apparatus according to a first embodiment;

FIG. 2-1 is a cleaning process diagram (1) of the first embodiment;

FIG. 2-2 is a cleaning process diagram (2) of the first embodiment;

FIG. 2-3 is a cleaning process diagram (3) of the first embodiment;

FIG. 3 is an enlarged view showing an apparatus essential part of a second embodiment;

FIG. 4-1 is a cleaning process diagram (1) of the second embodiment;

FIG. 4-2 is a cleaning process diagram (2) of the second embodiment;

FIG. 4-3 is a cleaning process diagram (3) of the second embodiment;

FIG. 5-1 is an enlarged view (1) showing a cleaning jig according to a third embodiment;

FIG. 5-2 is an enlarged view (2) illustrating the cleaning jig according to the third embodiment;

FIG. 6-1 is a cleaning process diagram (1) of the third embodiment;

FIG. 6-2 is a cleaning process diagram (2) of the third embodiment;

FIG. 6-3 is a cleaning process diagram (3) of the third embodiment;

FIG. 7 is a configuration diagram showing a polymer removing apparatus according to a prior art;

FIG. 8-1 is a cleaning process diagram (1) of the prior art;

FIG. 8-2 is a cleaning process diagram (2) of the prior art; and

FIG. 8-3 is a cleaning process diagram (3) of the prior art.

### DETAILED DESCRIPTION OF THE PREFERRED EMBODIMENTS

Preferred embodiments of the present invention will hereinafter be described with reference to the accompanying drawings. Incidentally, the shape, size and layout relationship of each constituent element or component in the figures are merely approximate illustrations to enable an understanding of the present invention. Therefore, the present invention is not limited only to examples illustrated in the figures. The common constituent elements and like constituent elements in the respective figures are given the same reference numerals, and their dual explanations are omitted.

### First Preferred Embodiment

<Configuration of Polymer Removing Apparatus>

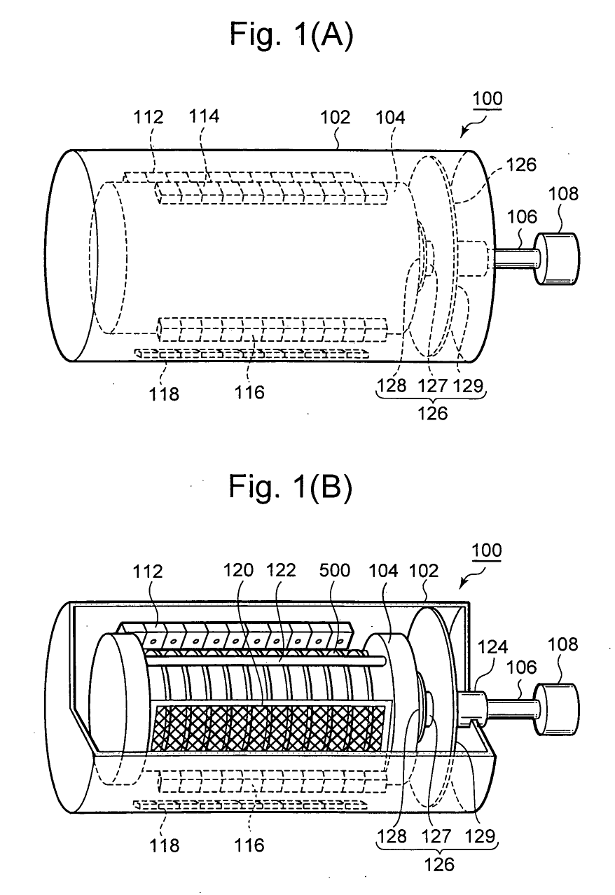

A configuration of a polymer removing apparatus according to the present embodiment will hereinafter be explained referring to FIGS. 1(A) and 1(B). Incidentally, FIG. 1(A) is a diagram showing the outward appearance of the polymer removing apparatus. FIG. 1(B) is a diagram showing the configuration of the polymer removing apparatus in which a chamber shown in FIG. 1 is partly cut away.

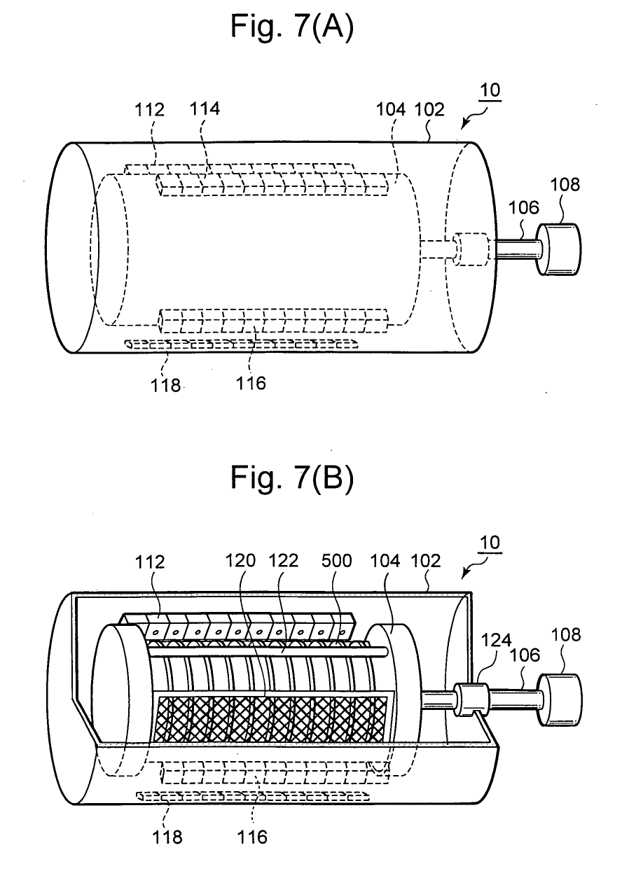

The polymer removing apparatus 100 has a configuration in which a rotational-shaft seal section protective plate 126 is added to the conventional polymer removing apparatus 10 (see FIG. 7).

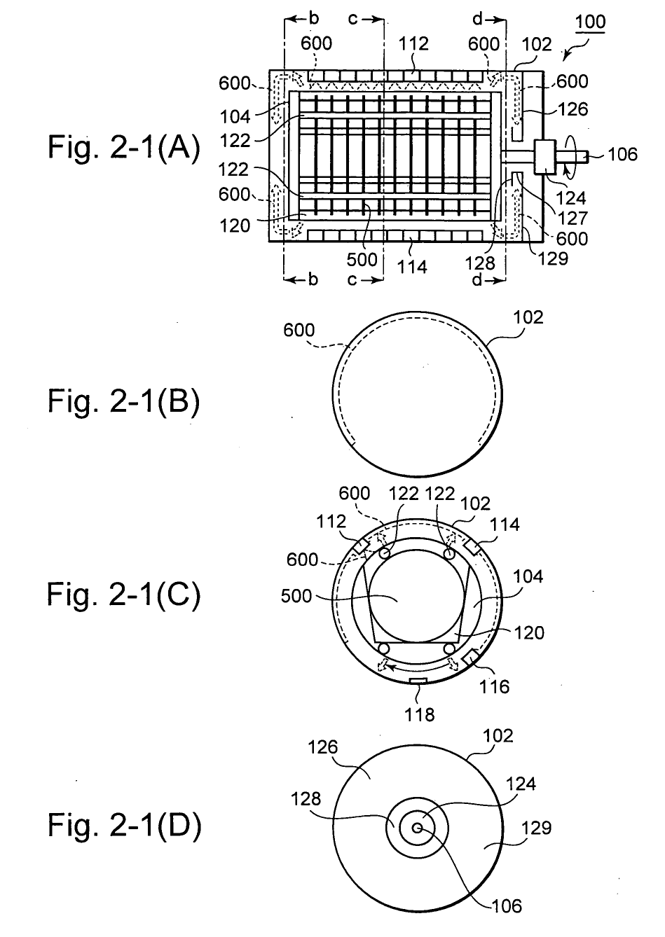

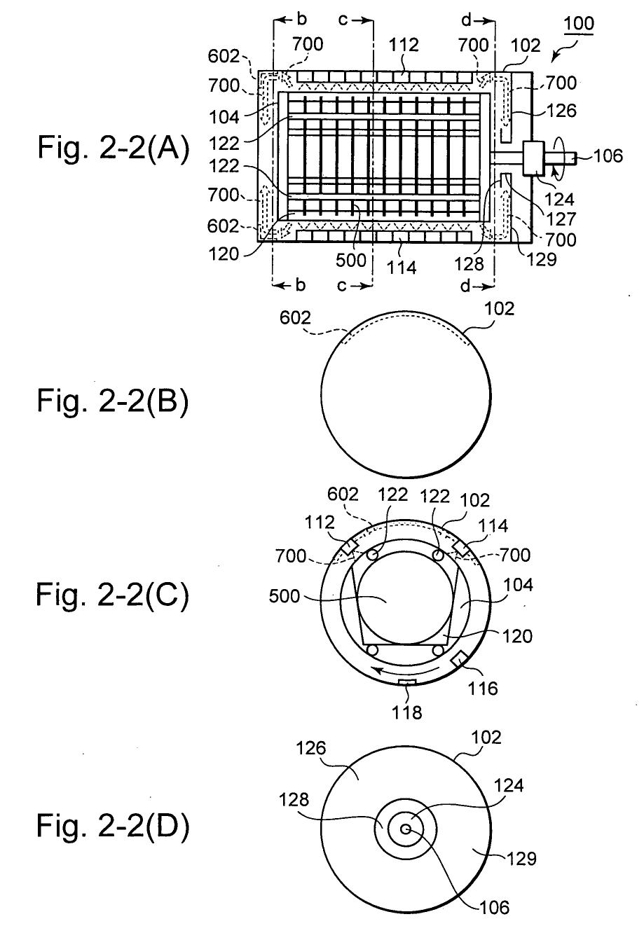

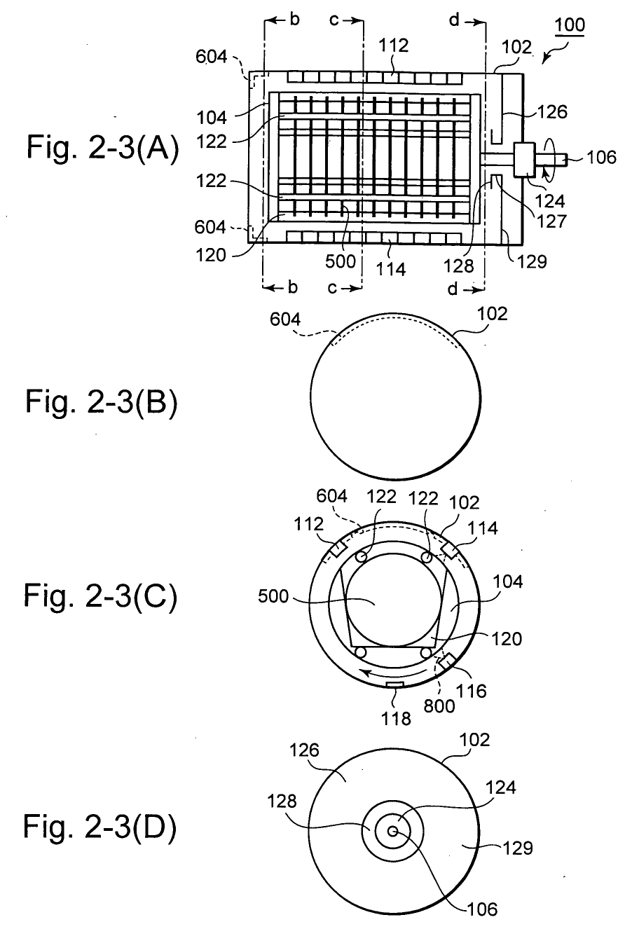

The rotational-shaft seal section protective plate 126 is a member which partitions or divides the interior of the chamber 102 into a portion on the rotor 104 side and a portion on the rotational-shaft seal section 124 side and prevents a removing or peeling liquid 600 (refer to FIG. 2-1) from entering the portion on the rotational-shaft seal section 124 side lying inside the chamber 102.

The rotational-shaft seal section protective plate 126 includes a cylindrical section 127, and flange-shaped sections 128 and 129 formed at both ends of the cylindrical section 127 as viewed in the axial direction of a rotating shaft 106. The cylindrical section 127 is disposed so as to cover the periphery of part of the rotating shaft 106 over its entire circumference along the rotating shaft 106. Further, the flange-shaped section 128 is a collared protruding portion formed within the plane orthogonal to the rotating shaft 106 at the end on the rotor 104 side, of the cylindrical section 127. On the other hand, the flange-shaped section 129 is a collared protruding portion formed within the plane orthogonal to the rotating shaft 106 at the end on the rotational-shaft seal section 124 side, of the cylindrical section 127. The flange-shaped section 128 is formed smaller in diameter than the flange-shaped section 129. Hereinafter, the flange-shaped section 128 is referred to as a small-diameter flange-shaped section 128 and the flange-shaped section 129 is called a large-diameter flange-shaped section 129.

The small-diameter flange-shaped section 128 functions as a guide for guiding a liquid injection medium (corresponding to each of the peeling liquid 600 and cleaning liquid 700 in the present embodiment (refer to FIGS. 2-1 and 2-2)) to a discharge port 118 with a high degree of efficiency.

The large-diameter flange-shaped section 129 functions as a partition for dividing the interior of the chamber 102 into the portion on the rotor 104 side and the portion on the rotating-shaft seal section 124 side.

<Operation of Polymer Removing Apparatus>

Cleaning operations to be performed by the polymer removing apparatus 100 will be explained below with reference to FIGS. 2-1 through 2-3. In FIGS. 2-1 through 2-3, the cleaning operations (refer to FIGS. 8-1 through 8-3) similar to the conventional example are given the same reference numerals, and the conventional polymer removing apparatus 10 will be explained with being read as the polymer removing apparatus 100.

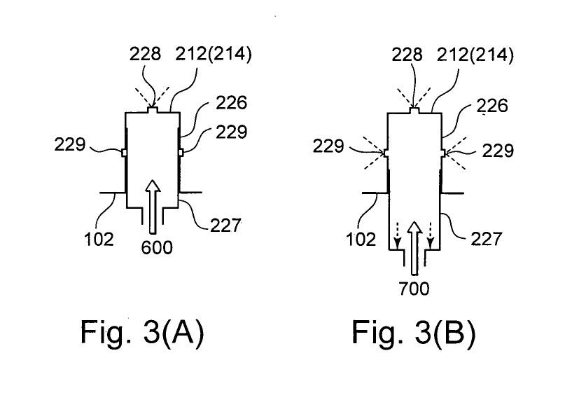

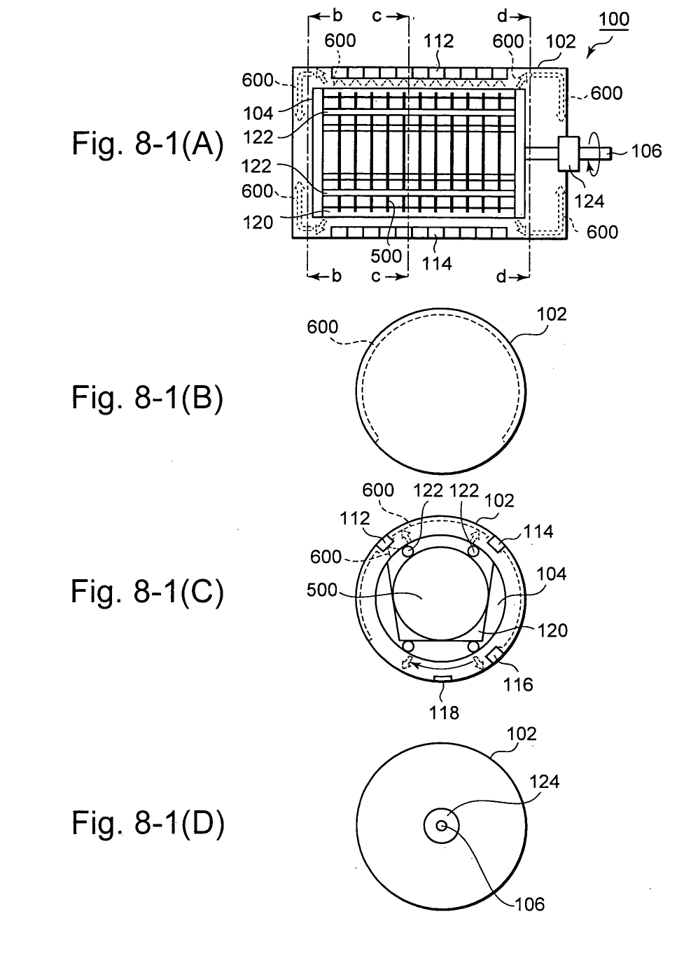

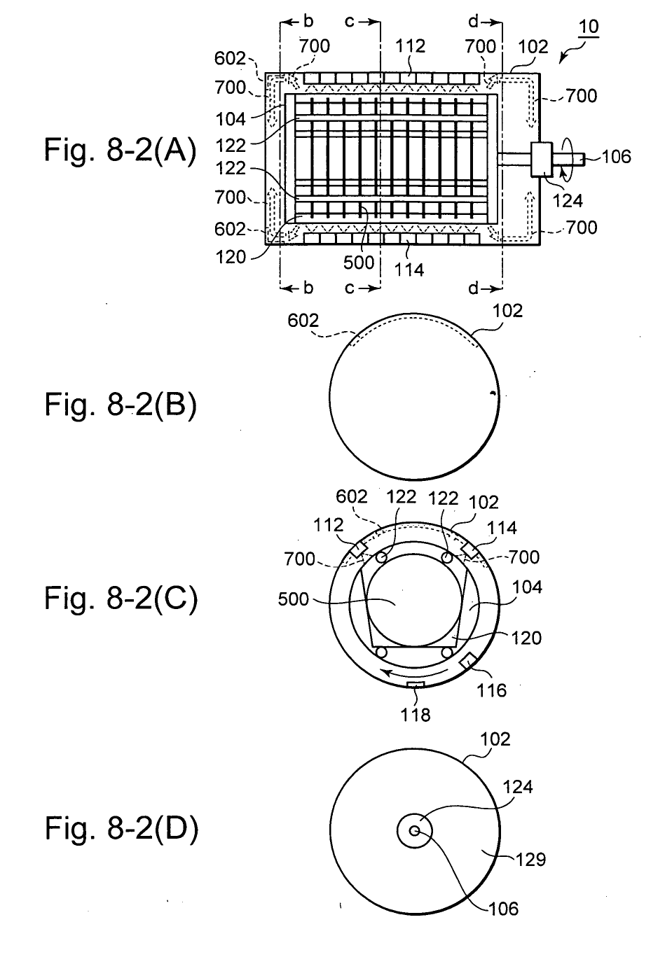

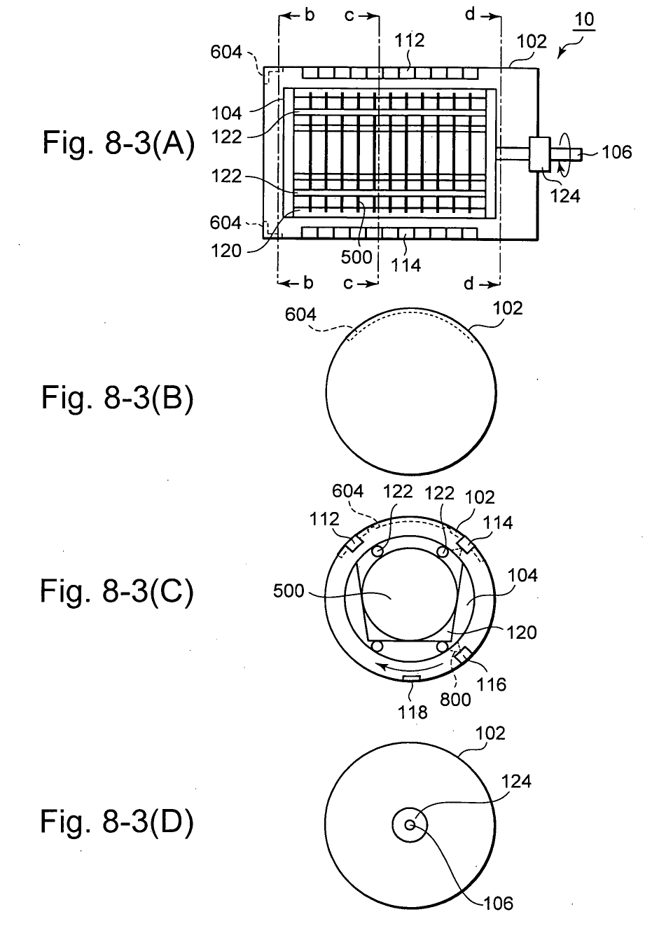

In a manner similar to FIG. 8-1, FIG. 2-1 is a diagram for describing a state in which the polymer removing apparatus 100 injects the peeling liquid 600. In a manner similar to FIG. 8-2, FIG. 2-2 is a diagram for describing a state in which the polymer removing-apparatus 100 injects the cleaning liquid 700. In a manner similar to FIG. 8-3, FIG. 2-3 is a diagram for describing a state in which the polymer removing apparatus 100 injects drying nitrogen 800. Incidentally, FIG. 2-1(A) through 2-3(A) in FIGS. 2-1 through 2-3 are respectively diagrams showing internal configurations of the polymer removing apparatus 100 as viewed from above. FIGS. 2-1(B) through 2-3(B) to FIGS. 2-1(D) through 2-3(D) in FIGS. 2-1 through 2-3 are respectively diagrams showing internal configurations of the polymer removing apparatus 100 as viewed from the side. Incidentally, each of FIGS. 2-1(B) through 2-3(B) is a diagram showing an internal state of the polymer removing apparatus 100 in which the chamber 102 is cut along line b-b in each of FIGS. 2-1(A) through 2-3(A). Each of FIGS. 2-1(C) through 2-3(C) is a diagram showing an internal state of the polymer removing apparatus 100 in which the chamber 102 is cut along line c-c in each of FIGS. 2-1(A) through 2-3(A). Each of FIGS. 2-1(D) through 2-3(D) is a diagram showing an internal state of the polymer removing apparatus 100 in which the chamber 102 is cut along line d-d in each of FIGS. 2-1(A) through 2-3(A). Incidentally, diagonally-shaded arrows in FIG. 2-2 indicate points where the impetus of an injection medium (corresponding to each of the peeling liquid 600 and cleaning liquid 700 in the present embodiment) is stronger than that employed in the conventional polymer removing apparatus 10 (refer to FIGS. 8-1 through 8-3).

In the polymer removing apparatus 100 as shown in FIGS. 2-1(A) through 2-1(D), a wafer carrier 120 which bears plural wafers 500 more than one, is accommodated in the rotor 104, and a drive unit 108 rotatably drives the rotor 104 about the rotating shaft 106.

And the polymer removing apparatus 100 injects the peeling liquid 600 to the wafers 500 lying inside the rotor 104 through first nozzles 112 disposed obliquely upward on the rotor 104, while the rotor 104 is being rotatably driven. Then, the polymer removing apparatus 100 discharges the injected peeling liquid 600 from the discharge port 118 to the outside of the chamber 102. The injected peeling liquid 600 peels off polymer from the wafers 500.

At this time, the peeling liquid 600 collides with the rotated rotor 104 and rebounds therefrom. Therefore, the peeling liquid 600 adheres to an inner wall of the chamber 102.

In the polymer removing apparatus 100 according to the present embodiment, the rotating-shaft seal section protective plate 126 prevents the peeling liquid 600 from entering the portion on the portion on the rotating-shaft seal section 124 side lying inside the chamber 102. Therefore, the peeling liquid 600 is adhered to the rotating-shaft seal section protective plate 126 without adhering to the periphery of the rotating-shaft seal section 124.

Next, as shown in FIGS. 2-2(A) through 2-2(D), the polymer removing apparatus 100 injects the cleaning liquid 700 to the wafers 500 lying inside the rotor 104 through the first nozzles 112 and second nozzles 114 disposed obliquely upward on the rotor 104 while the rotor 104 is being rotatably driven. Then, the polymer removing apparatus 100 discharges the injected cleaning liquid 700 from the discharge port 118 to the outside of the chamber 102. The injected cleaning liquid 700 washes out the peeling liquid 600 adhered to the wafers 500, the inner wall of the chamber 102 and the like.

In the polymer removing apparatus 100 according to the present embodiment, the following operations of the large-diameter flange-shaped section 129 and small-diameter flange-shaped section 128 of the rotating-shaft seal section protective plate 126 prevent the peeling liquid 600 (remaining peeling liquid 602) from remaining on the inner wall of the chamber 102 in the vicinity of its corner and on the periphery of the rotating-shaft seal section 124.

That is, the polymer removing apparatus 100 divides the interior of the chamber 102 into the portion on the rotor 104 side and the portion on the rotating-shaft seal section 124 side by means of the large-diameter flange-shaped section 129.

Thus, the peeling liquid 600 does not enter into the portion on the rotating-shaft seal section 124 side lying inside the chamber 102. Therefore, the polymer removing apparatus 100 is capable of preventing the adhesion of the peeling liquid 600 to the rotating-shaft seal section 124.

As a result, the polymer removing apparatus 100 can prevent the rotating-shaft seal section 124 from being eroded by the peeling liquid 600, thereby making it possible to make the lifetime of the rotating-shaft seal section 124 longer than conventional.

The farthest position (hereinafter called “peeling-liquid attainable position”) on the rotating-shaft seal section 124 side where the peeling liquid 600 reaches, is shifted from the cornered position of the inner wall of the chamber 102 to a position where the inner wall of the chamber 102 and the large-diameter flange-shaped section 129 intersect. Thus, the polymer removing apparatus 100 makes shorter the distance between each of the nozzles (first and second nozzles 112 and 114 in the present embodiment) and the peeling-liquid attainable position than conventional. This makes the impetus of the cleaning liquid 700 in the vicinity of the peeling-liquid attainable position stronger than conventional. Therefore, the polymer removing apparatus 100 is capable of efficiently washing out the peeling liquid 600 in the vicinity of the peeling-liquid attainable position with the cleaning liquid.

As a result, the polymer removing apparatus 100 is capable of reducing the amount (i.e., the amount of particles developed inside the apparatus) of the remaining peeling liquid 602 lying inside the apparatus as compared with the conventional one. Therefore, the polymer removing apparatus 100 is capable of reducing the frequency of occurrence of contamination of the wafers 500 by the particles as compared with the prior art and enhancing the yields of wiring for the wafers 500 than conventional.

The polymer removing apparatus 100 allows the small-diameter flange-shaped section 128 to lead the liquid injection mediums (peeling liquid 600 and cleaning liquid 700 in the present embodiment) to the discharge port 118 with efficiency.

Thus, the polymer removing apparatus 100 is capable of efficiently discharging the peeling liquid 600 to the outside thereof.

As a result, the polymer removing apparatus 100 is able to reduce the amount (i.e., the amount of particles produced inside the apparatus) of the remaining peeling liquid 602 lying inside the apparatus than conventional. Therefore, the polymer removing apparatus 100 is capable of reducing the frequency of occurrence of contamination of the wafers 500 by the particles as compared with the prior art and enhancing the yields of wiring for the wafers 500 than conventional.

By doing so, the polymer removing apparatus 100 according to the present embodiment prevents the peeling liquid 600 (remaining peeling liquid 602) from being left on the inner wall of the chamber 102 in the vicinity of the rotating-shaft seal section 124 and its corner.

Incidentally, the rotating-shaft seal section protective plate 126 cannot achieve such action in the case of a form merely constituted of the large-diameter flange-shaped section 129 and a form constituted of the cylindrical section 127 and the large-diameter flange-shaped section 129. Therefore, a form constituted of the cylindrical section 127, the small-diameter flange-shaped section 128 and the large-diameter flange-shaped section 129 is most suitable for the form of the rotating-shaft seal section protective plate 126.

Next, as shown in FIGS. 2-3(A) through 2-3(D), the polymer removing apparatus 100 injects the drying nitrogen 800 through third nozzles 116 to dry the wafers 500 and the inner wall of the chamber 102.

Incidentally, the amount of crystallized peeling liquid 604 developed inside the apparatus is less than conventional in the polymer removing apparatus 100 because the amount of the peeling liquid 600 (residual peeling liquid 602) remaining inside the apparatus is less than conventional. Therefore, the polymer removing apparatus 100 is capable of reducing the frequency of occurrence of contamination of the wafers 500 by the particles as compared with the prior art and enhancing the yields of wiring for the wafers 500 than conventional.

According to the present embodiment as described above, it is possible to prevent the rotating-shaft seal section from being eroded by the peeling liquid and make the lifetime of the rotating-shaft seal section longer than conventional. Therefore, the cost taken for each expendable part can be reduced.

According to the present embodiment as well, the amount of residual peeling liquid (i.e., the amount of particles developed inside the apparatus) lying inside the apparatus can be reduced as compared with the prior art. It is therefore possible to reduce the frequency of occurrence of contamination of the wafers by the particles than conventional and enhance the yields of wiring for the wafers than conventional.

### Second Preferred Embodiment

<Configuration of Polymer Removing Apparatus>

The present embodiment shows an example in which the first and second nozzles 112 and 114 of the conventional polymer removing apparatus 10 are changed in structure.

Configurations of nozzles each showing an essential part of the polymer removing apparatus according to the present embodiment will be explained below referring to FIGS. 3(A) and 3(B). Incidentally, FIG. 3(A) shows the state of the nozzle at the injection of a peeling liquid 600. FIG. 3(B) illustrates the state of the nozzle at the injection of a cleaning liquid 700.

The polymer removing apparatus 200 (refer to FIGS. 4-1 through 4-3) according to the present embodiment has a configuration similar to the conventional polymer removing apparatus 10 (see FIG. 7). However, the polymer removing apparatus 200 has a first nozzle 212 and a second nozzle 214 as an alternative to the first nozzle 112 and the second nozzle 114 of the conventional removing apparatus 10.

At least one (both in the present embodiment) of the first and second nozzles 212 and 214 is equipped with a variable mechanism for changing the direction of injection of each injection medium. In the present embodiment, the variable mechanism is realized by a first cylinder 226 fixed to a chamber 102 and a second cylinder 227 which slides along the interior of the first cylinder 226.

The first cylinder 226 includes a plurality of nozzles defined one by one in respective surfaces exposed inside the chamber 102. In the present embodiment, an injection hole placed at the tip face of the first cylinder 226 is called injection hole 228, and injection holes disposed at the side faces of the first cylinder 226 are called injection holes 229. Incidentally, the example illustrated in FIG. 3 shows portions other than both ends of the nozzles 212 and 214. Since the number of the side faces of the first cylinder 226 exposed inside the chamber 102 is two in the present example, the number of the injection holes 229 becomes two. Since, however, the number of the side faces of the first cylinder 226 exposed inside the chamber 102 becomes three at both ends of the nozzles 212 and 214, the number of the injection holes 229 results in three.

The second cylinder 227 slides on the interior of the first cylinder 226. At this time, the second cylinder 227 suitably opens and closes some of the injection holes 228 and 229 of the first cylinder 226 depending upon its stop positions.

For instance, FIG. 3(A) is a diagram showing the state of the nozzle at the injection of the peeling liquid 600 as described above. At this time, the tip or leading end of the second cylinder 227 stops at a position close to the tip of the first cylinder 226. At this time, the second cylinder 227 opens the injection hole 228 at the tip face of the first cylinder 226 and closes the respective injection holes 229 at the side faces of the first cylinder 226. Therefore, the nozzle (first nozzle 212 in the present embodiment) serves so as to inject the peeling liquid 600 only from the injection hole 228 at the tip face of the first cylinder 226 at this time. Incidentally, an open arrow in FIG. 3(A) indicates the flow of the peeling liquid 600 in the nozzle.

On the other hand, FIG. 3(B) is a diagram showing the state of the nozzle at the injection of the cleaning liquid 700 as mentioned above. Incidentally, arrows indicated by black dotted lines in FIG. 3(B) show that the second cylinder 227 is moved from the position shown in FIG. 3(A). At this time, the tip or leading end of the second cylinder 227 stops at a position distant from the leading end of the first cylinder 226. At this time, the second cylinder 227 opens all injection holes 228 and 229 of the first cylinder 226. Therefore, the nozzles (first and second nozzles 212 and 214 in the present embodiment) inject the cleaning liquid 700 through all the injection holes 228 and 229 of the first cylinder 226 at this time. Incidentally, an open arrow in FIG. 3(B) indicates the flow of cleaning liquid 700 in the nozzle.

Incidentally, the injection direction of the injection hole 228 is set to within a range as viewed in the direction which forms an angle of about 90±10° with respect to the tip face of the first cylinder 226. Further, the injection direction of each injection hole 229 is set to within a range as viewed in the direction which forms an angle of about 90±10° with respect to the side face of the first cylinder 226. At both ends of the nozzles 212 and 214, however, the injection direction of each injection hole 229 may preferably be set to the direction of the position where the inner wall of the chamber 102 and the large-diameter flange-shaped section 129 of the rotating-shaft seal section protective plate 126 intersect.

<Operation of Polymer Removing Apparatus>

Cleaning operations to be performed by the polymer removing apparatus 200 will be explained below with reference to FIGS. 4-1 through 4-3. In FIGS. 4-1 through 4-3, the cleaning operations (refer to FIGS. 8-1 through 8-3) similar to the conventional example are given the same reference numerals. The conventional polymer removing apparatus 10 will be explained with being read as the polymer removing apparatus 200, and the first nozzles 112 and the second nozzles 114 will be explained with being read as the first nozzles 212 and the second nozzles 214.

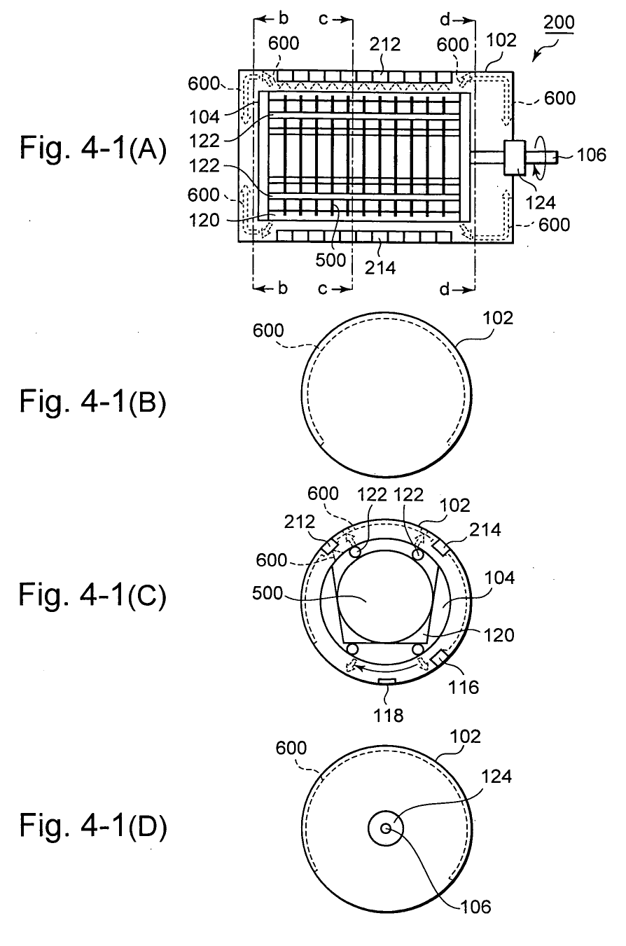

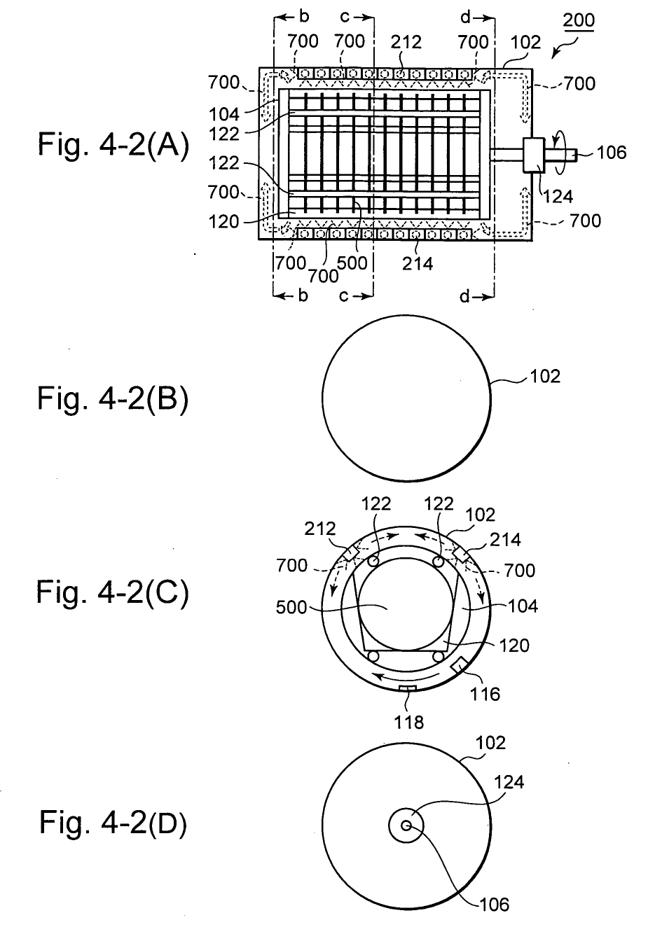

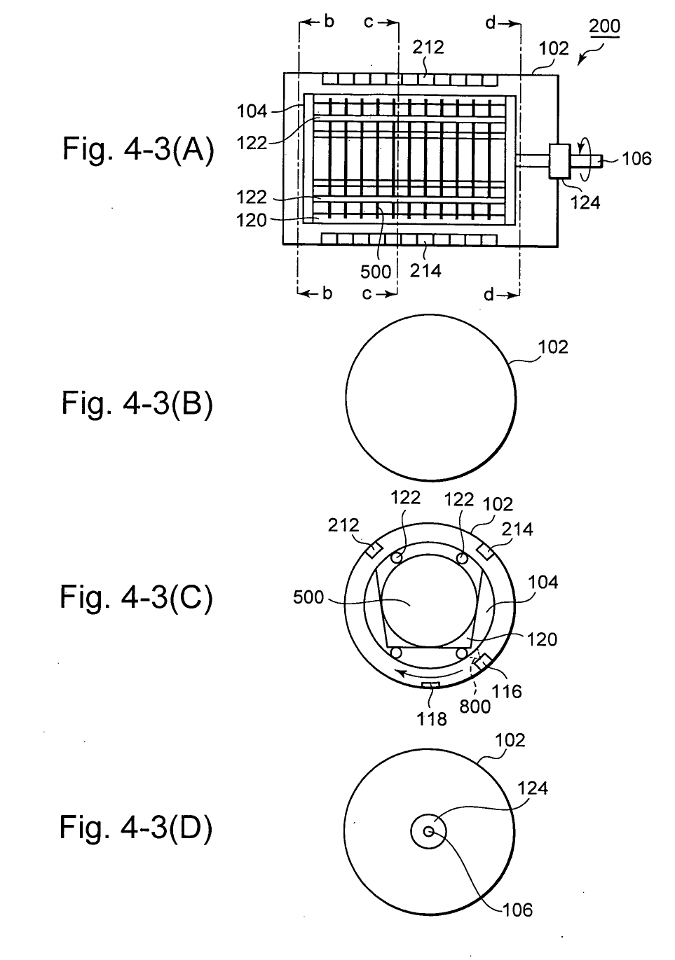

In a manner similar to FIG. 8-1, FIG. 4-1 is a diagram for describing a state in which the polymer removing apparatus 100 injects the peeling liquid 600. In a manner similar to FIG. 8-2, FIG. 4-2 is a diagram for describing a state in which the polymer removing apparatus 200 injects the cleaning liquid 700. In a manner similar to FIG. 8-3, FIG. 4-3 is a diagram for describing a state in which the polymer removing apparatus 200 injects drying nitrogen 800. Incidentally, diagonally-shaded arrows in FIG. 4-2 indicate points where the impetus of an injection medium (corresponding to each of the peeling liquid 600 and cleaning liquid 700 in the present embodiment) is stronger than that employed in the conventional polymer removing apparatus 10 (refer to FIGS. 8-2).

In the polymer removing apparatus 200 as shown in FIGS. 4-1(A) through 4-1(D), a wafer carrier 120 which bears plural wafers 500 more than one, is accommodated in the rotor 104, and a drive unit 108 (see FIG. 7) rotatably drives the rotor 104 about the rotating shaft 106.

And the polymer removing apparatus 200 injects the peeling liquid 600 to the wafers 500 lying inside the rotor 104 through the injection holes 228 of the first nozzles 112 disposed obliquely upward on the rotor 104, while the rotor 104 is being rotatably driven. Then, the polymer removing apparatus 200 discharges the injected peeling liquid 600 from the discharge port 118 to the outside of the chamber 102. The injected peeling liquid 600 peels off polymer from the wafers 500.

At this time, in the polymer removing apparatus 200 according to the present embodiment, the peeling liquid 600 adheres particularly to the inner wall of the chamber 102 in the vicinity of the rotating-shaft seal section 124 in a manner similar to the conventional polymer removing apparatus 10 (refer to FIG. 4-1(D)).

Next, as shown in FIGS. 4-2(A) through 4-2(D), the polymer removing apparatus 200 injects the cleaning liquid 700 to the wafers 500 lying inside the rotor 104 through all the injection holes 228 and 229 of the first nozzles 212 and second nozzles 214 disposed obliquely upward on the rotor 104 while the rotor 104 is being rotatably driven. Then, the polymer removing apparatus 200 discharges the injected cleaning liquid 700 from the discharge port 118 to the outside of the chamber 102. The injected cleaning liquid 700 washes out the peeling liquid 600 adhered to the wafers 500, the inner wall of the chamber 102 and the like.

Incidentally, at this time, the first nozzles 212 and the second nozzles 214 serve so as to inject the cleaning liquid 700 through all the injection holes 228 and 229. Therefore, the cleaning liquid 700 is injected radially and in a multi-direction with strong power. Thus, the polymer removing apparatus 200 can wash out substantially all the peeling liquid 600 adhered to the inner wall of the chamber 102 with the cleaning liquid.

Next, as shown in FIGS. 4-3(A) through 4-3(D), the polymer removing apparatus 200 injects drying nitrogen 800 from third nozzles 116 and dries the wafers 500, the inner wall of the chamber 102 and the like.

Incidentally, since the peeling liquid 600 remaining inside the apparatus little exists in the polymer removing apparatus 200, there is little crystallized peeling liquid 604 developed inside the apparatus. Therefore, the polymer removing apparatus 200 is capable of reducing the frequency of occurrence of contamination of the wafers 500 by particles than conventional and enhancing the yields of wiring for the wafers 500 than conventional.

As described above, the polymer removing apparatus 200 according to the present embodiment can inject the peeling liquid 600 and the cleaning liquid 700 by performing switching to the injection direction of the injection medium. Therefore, the polymer removing apparatus 200 can radially inject the cleaning liquid 700 when, for example, the cleaning liquid 700 is injected.

Such a polymer removing apparatus 200 can supply a powerful or vigorous cleaning liquid 700 even to spots to which the cleaning liquid 700 has not heretofore been distributed sufficiently. Therefore, the polymer removing apparatus 200 can wash out the peeling liquid 600 with the cleaning liquid with efficiency.

As a result, the polymer removing apparatus 200 can make the amount (i.e., the amount of particles produced inside the apparatus) of the residual peeling liquid 602 lying inside the apparatus less than conventional. Therefore, the polymer removing apparatus 200 can reduce the frequency of occurrence of contamination of the wafers 500 by the particles as compared with the prior art and enhance the yields of wiring for the wafers 500 than conventional.

### Third Preferred Embodiment

The present embodiment shows an example in which a cleaning operation for replacing a wafer carrier held in a rotor with a cleaning jig and injecting a cleaning liquid to the cleaning jig from the periphery of the rotor in a state in which the cleaning jig is accommodated in the rotor, while the rotor is being rotatably driven, is added after the cleaning operation (refer to FIG. 8-3) of the conventional example. Incidentally, the cleaning jig is a water wheel which has side faces formed in a plane fashion and splashes the injected cleaning liquid toward an inner wall of a chamber with powerful impetus. In the present embodiment, the cleaning liquid is vigorously splashed toward the inner wall of the chamber through the side faces of the cleaning jig, thereby making it possible to apply the vigorous cleaning liquid even to spots to which the cleaning liquid has not heretofore been applied sufficiently. It is therefore possible to efficiently wash out the peeling liquid with the cleaning liquid in the present embodiment. Incidentally, the configuration per se of the polymer removing apparatus according to the present embodiment is identical to the conventional example.

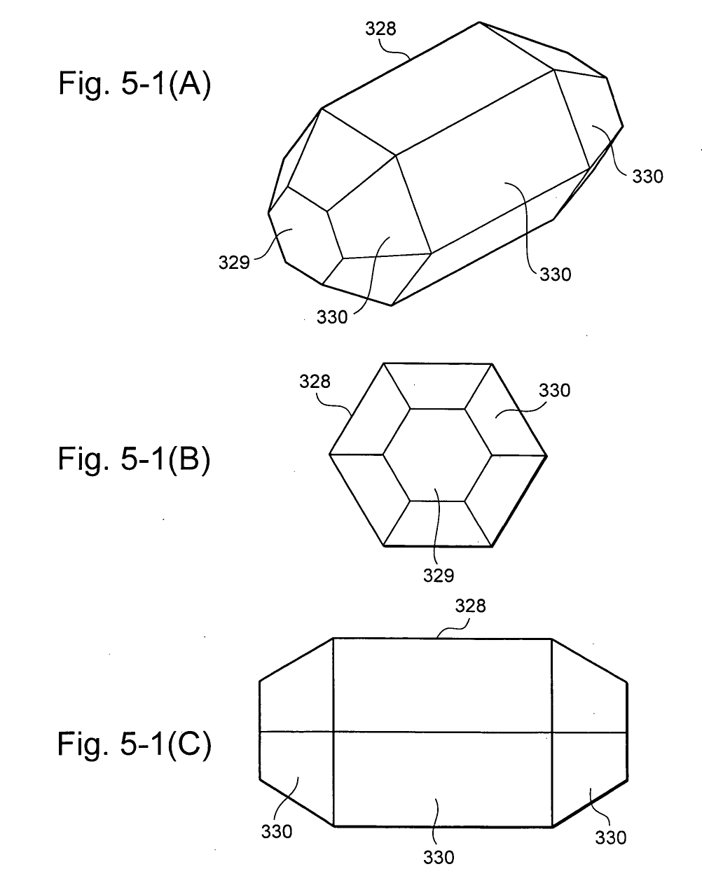

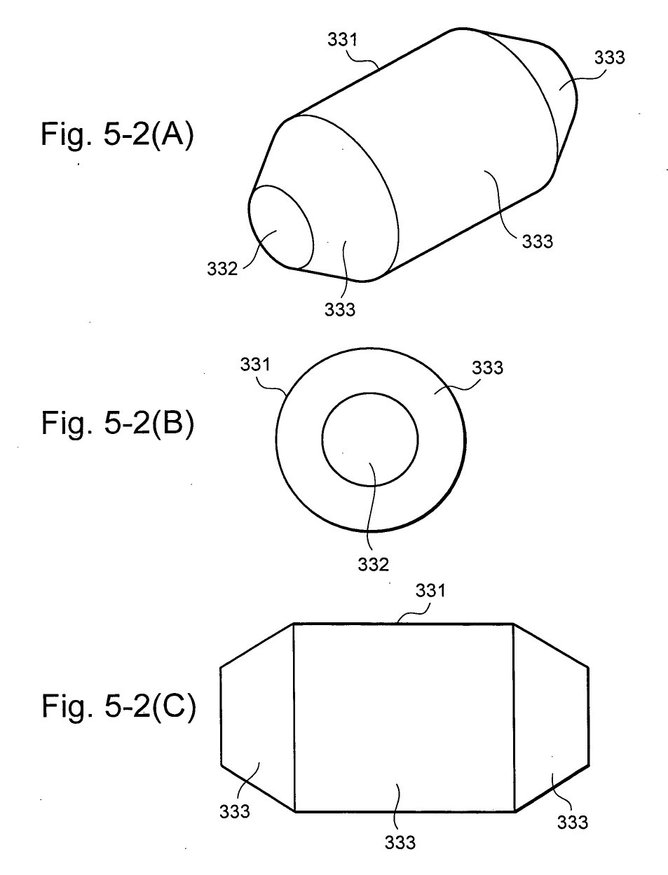

The configuration of the cleaning jig will be explained below referring to FIGS. 5-1 and 5-2. Incidentally, FIG. 5-1 is a diagram showing one example of the cleaning jig, and FIG. 5-2 is a diagram showing another example of the cleaning jig. FIG. 5-1(A) and FIG. 5-2(A) are diagrams showing the configurations of the cleaning jigs as seen from their oblique directions respectively. FIG. 5-1(B) and FIG. 5-2(B) are diagrams showing the configurations of the cleaning jigs as seen from their tip face directions respectively. FIG. 5-1(C) and FIG. 5-2(C) are diagrams showing the configurations of the cleaning jigs as seen from their side face directions respectively.

The cleaning jig 328 shown in FIGS. 5-1(A) through 5-1(C) is shaped in the form of a hexagonal column. Incidentally, the cleaning jig 328 is not limited to the hexagonal column but may be shaped in the form of a triangular column, a quadrangular column and other polygonal column. The cleaning jig 328 comprises two tip faces 329 each shaped in the form of a polygon, and a plurality of side faces 330. Incidentally, the respective side faces 330 of the cleaning jig 328 are obliquely cut away in the vicinity of the two tip faces 329 in the example shown in FIGS. 5-1(A) through 5-1(C). Therefore, the side faces 330 of the cleaning jig 328 shaped in the form of the hexagonal column are made up of eighteen surfaces. The eighteen side faces 330 serve as portions which accept the injection of the cleaning liquid 700.

The cleaning jig 331 shown in FIGS. 5-2(A) through 5-2(C) is shaped in the form of a circular cylinder or column. The cleaning jig 331 comprises two tip faces 332 each shaped in a circular form, and side faces 333. Incidentally, the side faces 333 of the cleaning jig 331 are obliquely cut away in the vicinity of the two tip faces 332 in the example shown in FIGS. 5-2(A) through 5-2(C). Therefore, the side faces 333 of the cleaning jig 331 shaped in the columnar form are constituted of three surfaces. The three side faces 333 serve as portions which accept the injection of the cleaning liquid 700.

Incidentally, the cleaning jig 328 of the two cleaning jigs 328 and 331 is capable of splashing out the cleaning liquid 700 with powerful impetus as compared with the cleaning jig 331. Therefore, the cleaning jig 328 is higher than the cleaning jig 331 in cleaning capability. Thus, the cleaning jig 328 is preferable to the cleaning jig 331.

Since the respective side faces 330 are obliquely cut away, the cleaning jig 328 can splash the cleaning liquid 700 in the oblique direction. Likewise, since the side faces 333 are obliquely cut away, the cleaning jig 331 is also capable of splashing the cleaning liquid 700 in the oblique direction. Therefore, the cleaning jigs 328 and 331 can splash the cleaning liquid 700 to an inner wall of a chamber 102 located in the vicinity of its corner with powerful impetus in particular. Hence, each of the cleaning jigs 328 and 331 can efficiently clean the inner wall of the chamber 10 in the neighborhood of its corner in particular.

The additional cleaning operations will be explained below referring to FIGS. 6-1 through 6-3. Although the additional cleaning operations are different from the cleaning operations of the conventional example in that the cleaning jig 328 or 331 is accommodated in the rotor 104 in place of the wafer carrier 120, the operations are equivalent to operations similar to the cleaning operations of the conventional example except for the above. Therefore, the additional cleaning operations will be explained in brief. Incidentally, the cleaning jig 328 is assumed to be held in the rotor 104 here.

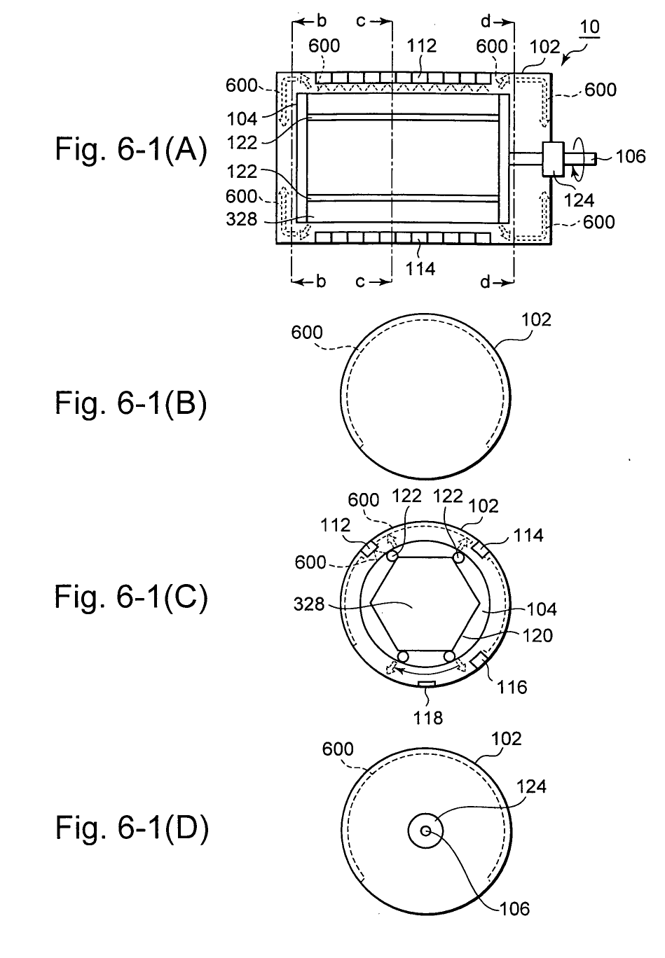

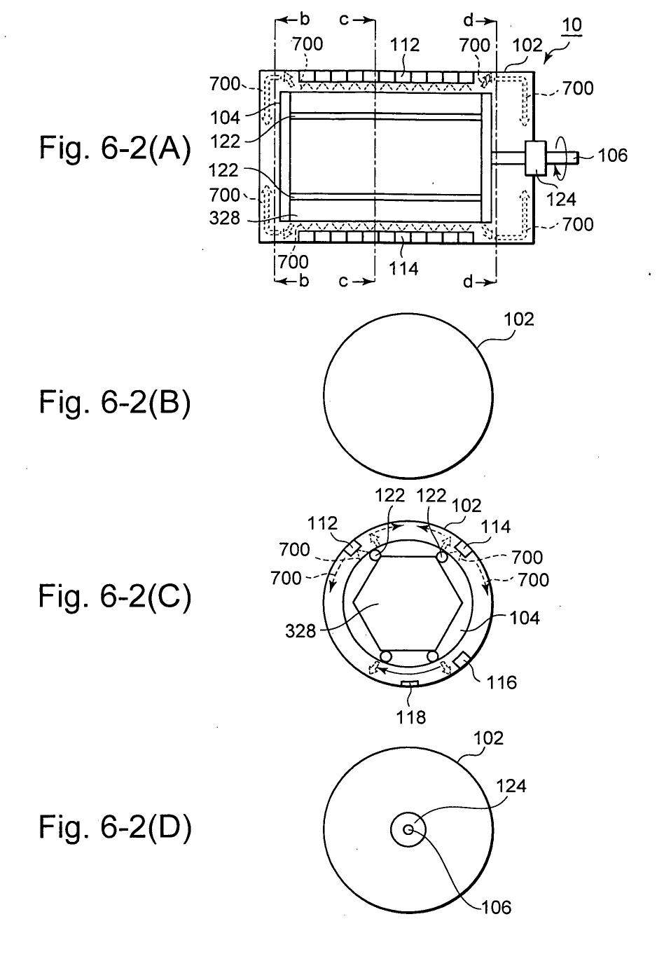

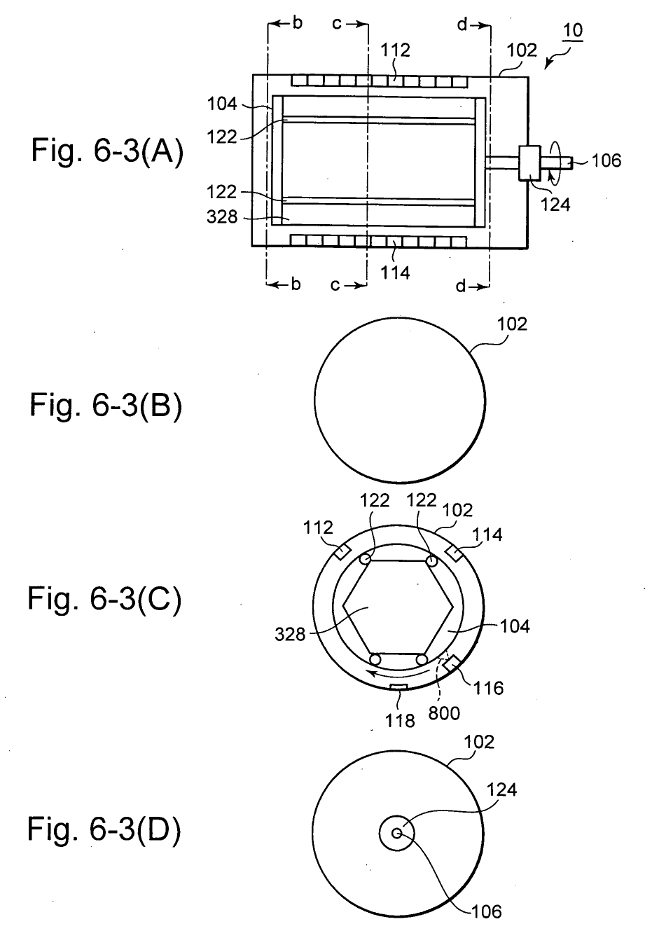

In a manner similar to FIG. 8-1, FIG. 6-1 is a diagram showing a state in which a polymer removing apparatus 10 injects a peeling liquid 600. In a manner similar to FIG. 8-2, FIG. 6-2 is a diagram showing a state in which the polymer removing apparatus 10 injects a cleaning liquid 700. In a manner similar to FIG. 8-3, FIG. 6-3 is a diagram showing a state in which the polymer removing apparatus 10 injects drying nitrogen 800. Incidentally, diagonally-shaded arrows in FIGS. 6-1 through 6-3 indicate spots at which the power or impetus of an injection medium (corresponding to each of the peeling liquid 600 and cleaning liquid 700 in the present embodiment) is strong as compared with the conventional cleaning operations (refer to FIGS. 8-1 through 8-3).

After the cleaning operation of the conventional example shown in FIG. 8-3, an operator replaces the wafer carrier 120 with the cleaning jig 328. That is, the operator detaches the wafer carrier 120 from the rotor 104 and instead holds the cleaning jig 328 in the rotor 104 (refer to FIG. 6-1). Thereafter, the polymer removing apparatus 10 performs additional cleaning operations shown in FIGS. 6-1 through 6-3.

As shown in FIG. 6-1(A) through 6(D), the polymer removing apparatus 10 includes the cleaning jig 328 accommodated in the rotor 104 and rotatably drives the rotor 104 about a rotating shaft 106 by means of a drive unit 108.

And the polymer removing apparatus 10 injects the peeling liquid 600 to the cleaning jig 328 lying inside the rotor 104 through first nozzles 112 disposed obliquely upward on the rotor 104, while the rotor 104 is being rotatably driven. Then, the polymer removing apparatus 100 discharges the injected peeling liquid 600 from its corresponding discharge port 118 to the outside of the chamber 102.

At this time, the peeling liquid 600 collides with the rotated cleaning jig 328 and rebounds therefrom with powerful impetus. Therefore, the peeling liquid 600 adheres to the inner wall of the chamber 102 and the periphery of a rotating-shaft seal section 124.

Next, as shown in FIGS. 6-2(A) through 6-2(D), the polymer removing apparatus 10 injects the cleaning liquid 700 to the cleaning jig 328 lying inside the rotor 104 through the first nozzles 112 and second nozzles 114 disposed obliquely upward on the rotor 104 while the rotor 104 is being rotatably driven. Then, the polymer removing apparatus 10 discharges the injected cleaning liquid 700 from the discharge port 118 to the outside of the chamber 102.

At this time, the cleaning liquid 700 collides with the rotated cleaning jig 328 and rebounds therefrom with powerful impetus. Therefore, the cleaning liquid 700 efficiently washes out the peeling liquid 600 adhered to the inner wall of the chamber 102, the periphery of the rotating-shaft seal section 124 and the like.

Next, as shown in FIGS. 6-3(A) through 6-3(D), the polymer removing apparatus 10 injects the drying nitrogen 800 from third nozzles 116 to dry the cleaning jig 328 and the inner wall of the chamber 102.

Incidentally, the cleaning jig 328 is capable of splashing the cleaning liquid 700 toward the inner wall of the chamber 102 by the side faces 330 of the hexagonal column. Thus, the cleaning method according to the present embodiment can apply the vigorous cleaning liquid 700 even to spots to which the cleaning liquid 700 has heretofore been unapplied sufficiently. Therefore, the cleaning method according to the present embodiment can efficiently wash out the peeling liquid 600 with the cleaning liquid.

As a result, since the peeling liquid 600 (residual peeling liquid 602) remaining inside the apparatus little exists quantitatively in the cleaning method according to the present embodiment, there is little crystallized peeling liquid 604 developed inside the apparatus. Therefore, the cleaning method according to the present embodiment is capable of reducing the frequency of occurrence of contamination of the wafers 500 by particles than conventional and enhancing the yields of wiring for the wafers 500 than conventional.

Incidentally, the present invention is not limited to the aforementioned embodiment, and various changes and modifications are considered within the scope not departing from the gist of the present invention.

The polymer removing apparatus preferably combines the configuration of the first embodiment with the configuration of the second embodiment. The method according to the third embodiment may most preferably be executed by using the polymer removing apparatus which combines the configurations of the first and second embodiments with each other. In this case, the polymer removing apparatus is capable of most efficiently reducing the particles that remain inside the apparatus.

What is claimed is:

1. A polymer removing apparatus which removes polymer from each of wafers, comprising:
a chamber whose inside is hollow;
a plurality of nozzles which are disposed over an inner wall of the chamber and inject a liquid or gaseous injection medium to the wafers lying in the chamber;
a discharge port which is disposed inside the chamber and discharges the injection medium to the outside of the chamber;
a rotor which is disposed inside the chamber and accommodates a wafer carrier bearing the wafers therein;
a drive unit which is disposed outside the chamber and rotates the rotor;
a rotating shaft which connects the rotor and the drive unit;
a rotating-shaft seal section which seals between the rotating shaft and the chamber; and
a rotating-shaft seal section protective plate which is disposed between the rotor and the rotating-shaft seal section and protects the rotating-shaft seal section from the injection medium,
wherein the rotating-shaft seal section protective plate includes a cylindrical section which covers the periphery of part of the rotating shaft over its full circumstance, a large-diameter flange-shaped section formed at an end on the rotating-shaft seal section side, of the cylindrical section, and a small-diameter flange-shaped section formed at an end on the rotor side, of the cylindrical section.

2. A polymer removing apparatus which removes polymer from each of wafers, comprising:
a chamber whose inside is hollow;
a plurality of nozzles which are disposed over an inner wall of the chamber and inject a liquid or gaseous injection medium to the wafers lying in the chamber;
a discharge port which is disposed inside the chamber and discharges the injection medium to the outside of the chamber;
a rotor which is disposed inside the chamber and accommodates a wafer carrier bearing the wafers therein;
a drive unit which is disposed outside the chamber and rotates the rotor;
a rotating shaft which connects the rotor and the drive unit; and
a rotating-shaft seal section which seals between the rotating shaft and the chamber,
wherein at least one of a plurality of the nozzles includes a variable mechanism which changes an injection direction of the injection medium.

3. A method of cleaning the interior of a polymer removing apparatus, comprising the steps of:
injecting a cleaning liquid to wafers from the periphery of a rotor while rotatably driving the rotor in a state in which a wafer carrier bearing the wafers is being held in the rotor lying inside a chamber, thereby to clean the wafers;
replacing the wafer carrier with a cleaning jig having side faces each shaped in a plane fashion; and
injecting the cleaning liquid to the side faces of the cleaning jig from the periphery of the rotor while rotatably driving the rotor in a state in which the cleaning jig is being accommodated in the rotor lying inside the chamber, thereby to clean the inside of the chamber.

4. The method according to claim 3, wherein said chamber inside cleaning step is a step for splashing the cleaning liquid toward the inner wall of the chamber through respective side faces of a polygonal column with powerful impetus by using a jig shaped in the form of a the polygonal column as the cleaning jig.
